(19) United States
(12) Patent Application Publication
(10) Pub. No.: US 2010/0060807 A1
(43) Pub. Date: Mar. 11, 2010

(54) MEANS TO ENGAGE ELECTRONIC DISPLAY PANELS TO CONVENTIONAL PICTURE FRAMES

(76) Inventors: Daniel Green, Rochester, NY (US); Peter H. Jameson, Pittsford, NY (US); John T. Keech, Penfield, NY (US); Paul J. Klock, Rochester, NY (US); Gregory R. Kulzer, Rochester, NY (US); Lawrence B. Landry, Victor, NY (US); Martin A. Maurinus, Rochester, NY (US)

Correspondence Address: EASTMAN KODAK COMPANY;PATENT LEGAL STAFF, 343 STATE STREET, ROCHESTER, NY, 14650-2201, US

(21) Appl. No.: 12/551,703

(22) Filed: Sep. 1, 2009

Related U.S. Application Data
(60) Provisional application No. 61/094,652, filed on Sep. 5, 2008.

(51) Int. Cl. H04N 5/64

(52) U.S. Cl. 348/836; 348/E05.128

(57) ABSTRACT

Various techniques for detachably connecting a commercially-available convention picture frame to an electronic display panel, such as one used in a digital picture frame. The electronic display panel includes a display and a bordering housing surrounding the display and having an opening, that in combination with the opening in the conventional picture frame, allow the display to be visible through the openings. The height, width, and thickness of the bordering housing are configured to allow the electronic display panel to be engaged with multiple commercially-available conventional picture frames.

### CROSS-REFERENCE TO RELATED APPLICATION

This application claims the benefit of U.S. Provisional Application No. 61/094,652 filed on Sep. 5, 2008, which is incorporated herein by reference.

### TECHNICAL FIELD

The present invention relates generally to display devices such as digital picture frames, and more particularly to techniques for engaging commercially-available conventional picture frames to an electronic display panel.

### BACKGROUND

A digital display device, such as digital picture frame, is an increasingly popular product that allows a user to display multiple digital images with one single framed device. Traditional digital picture frames include an electronic display panel and a frame that is designed specifically for the electronic display panel. To allow users to be able to vary the look of a digital picture frame, some digital picture frame producers sell a limited number of frames that have each been designed to fit a particular model of a digital picture frame. Consequently, a user has limited options when customizing the look of a digital picture frame.

### SUMMARY

Various techniques are disclosed for detachably engaging a commercially-available conventional picture frame to an electronic display panel. The electronic display panel includes a display and a bordering housing surrounding the display. The height, width, and thickness of the bordering housing are configured to allow the electronic display panel to be engaged with multiple commercially-available conventional picture frames. One embodiment for detachably engaging a conventional picture frame to the electronic display panel includes deflectable clips affixed to a backside of the bordering housing, where the deflectable clips move into a slot formed in the commercially-available conventional picture frame in response to a force being applied to each clip. Another embodiment uses rotatable clips affixed to the picture frame to detachably engage the commercially-available conventional picture frame to the electronic display panel. Yet another embodiment employs corner clips inserted into two or more corners of the commercially-available conventional picture frame so that each corner clip is disposed between a backside of the bordering housing and the commercially-available conventional picture frame. A holdback plate having movable tabs can also be used to detachably engage the conventional picture frame to the electronic display panel. Pressure connectors, adhesive connectors, tab connectors, and a slot connector can also be used to detachably engage a commercially-available conventional picture frame to the electronic display panel. One or more of the techniques can further employ one or more expansive layers positioned between the backside of the bordering housing and the clips or connectors used to engage the commercially-available picture frame to the electronic display panel.

### ADVANTAGEOUS EFFECT

The present invention includes the advantage of allowing an electronic display panel of a digital display device, such as a digital picture frame, to be detachably engaged with a plurality of commercially-available picture frames.

### BRIEF DESCRIPTION OF THE DRAWINGS

Embodiments of the invention are better understood with reference to the following drawings. The elements of the drawings are not necessarily to scale relative to each other.

FIG. 1 depicts a front view of a conventional picture frame engaged to the front of an electronic display panel in an embodiment in accordance with the invention;

FIG. 2 is an exploded view of FIG. 1;

FIG. 3 is a back view of conventional picture frame engaged to the back of an electronic display panel in an embodiment in accordance with the invention;

FIG. 4 is a perspective rear view of one side of the conventional picture frame and the electronic display panel in a first embodiment in accordance with the invention;

FIG. 5 is a perspective rear view of one side of the conventional picture frame and the electronic display panel in a second embodiment in accordance with the invention;

FIG. 6 is a perspective rear view of one side of the conventional picture frame and the electronic display panel in a third embodiment in accordance with the invention;

FIG. 7 is a perspective rear view of one corner of the conventional picture frame and the electronic display panel in a fourth embodiment in accordance with the invention;

FIG. 8 a perspective rear view of one corner of the conventional picture frame and the electronic display panel in a fifth embodiment in accordance with the invention;

FIG. 9 is a perspective rear view of one side of the conventional picture frame and the electronic display panel in a sixth embodiment in accordance with the invention;

FIG. 10 is a perspective rear view of one side of the conventional picture frame and the electronic display panel in a seventh embodiment in accordance with the invention;

FIG. 11 depicts a cross-sectional view of a side of a conventional picture frame having alternative connection means that can be used to engage the conventional picture frame to an electronic display panel;

FIG. 12 depicts a cross-sectional view of a side of a conventional picture frame having alternative connection means that can be used to engage the conventional picture frame to an electronic display panel; and

FIG. 13 depicts a cross-sectional view of a side of a conventional picture frame having alternative connection means that can be used to engage the conventional picture frame to an electronic display panel.

### DETAILED DESCRIPTION

Throughout the specification and claims, the following terms take the meanings explicitly associated herein, unless the context clearly dictates otherwise. The meaning of “a,” “an,” and “the” includes plural reference, the meaning of “in” includes “in” and “on.” The term “connected” means either a direct connection between the items connected or an indirect connection through one or more intermediary devices. Referring to the drawings, like numbers indicate like parts throughout the views.

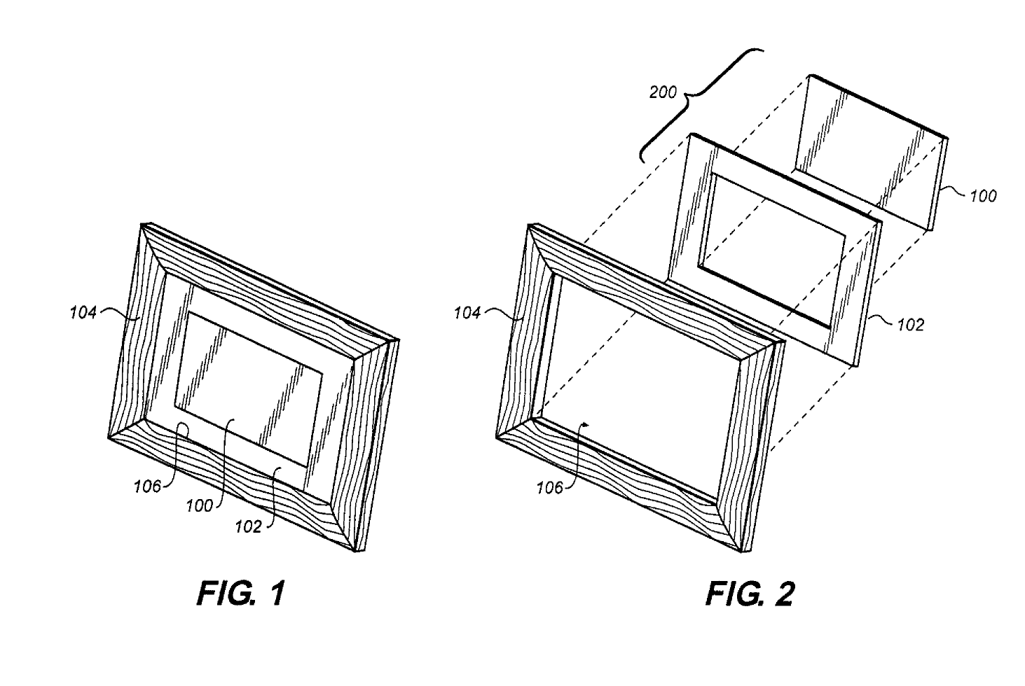

FIG. 1 depicts a front view of a conventional picture frame engaged to the front of an electronic display panel in an embodiment in accordance with the invention. FIG. 2 is an exploded view of FIG. 1. Electronic display panel includes display 100 and bordering housing 102. Display 100 can be implemented with any type of display, including, but not limited to, a liquid crystal display (LCD), plasma, digital light processing type (DLF), organic light emitting diode (OLED), liquid crystal on silicon (LCOS), and surface-conduction electron-emitter (SED). Bordering housing 102 can be fabricated with plastic, metal, wood, graphite fiber, composite, or any other suitable material.

Display 100 and bordering housing 102 are constructed as a single entity to form an electronic display panel 200 (see FIG. 2) in an embodiment in accordance with the invention. Bordering housing 102 can be configured as a single entity that attaches directly to frame 104 or, alternately, be configured as a panel and an adapter or other intermediary device that connects to frame 104.

Conventional picture frame 104 includes an opening 106 that allows display 100 and at least a portion of the front side of bordering housing 102 to be viewable in the embodiment shown in FIG. 1. Conventional picture frame 104 is a picture frame that is constructed for a known photograph size. For example, conventional picture frame 104 can be a 4×6, 5×7 or 8×10 picture frame.

Electronic display panel 200 is constructed to have a height, width, and thickness that allows panel 200 to be engaged with multiple conventional picture frames of a given size. The width and height of electronic display panel 200 are within a tenth of an inch of the stated width and height for a conventional picture frame in an embodiment in accordance with the invention. The tolerances of the height and width of electronic display panel 200 can have different values in other embodiments in accordance with the invention. For example, the height and width of panel 200 is within three or two tenths of an inch of the stated width and height of a conventional picture frame in another embodiment in accordance with the invention. And in yet another embodiment in accordance with the invention, the width and height are less than a tenth of an inch of the stated width and height of a conventional picture frame in another embodiment in accordance with the invention.

Moreover, the tolerances of the height and width of electronic display panel 200 do not have to be the same value. By way of example only, the height of panel 200 can be within two tenths of an inch of the stated height of a conventional picture frame while the width is less than a tenth of an inch of the stated width of the frame. As discussed earlier, electronic display panel 200 is designed to have a height and width that allows panel 200 to be engaged with two or more different conventional picture frames of a given size.

Bordering housing 102, or at least the outer portion of the edges of bordering housing 102, is designed with a thickness that allows the electronic display panel 200 to fit into multiple picture frames of a given size. The thickness of bordering housing 102, or at least the outer portions of the edges of bordering housing 102, is less than two tenths of an inch in an embodiment in accordance with the invention. The thickness of at least the outer portions of the edges of bordering housing 102 can be different in other embodiments in accordance with the invention. For example, the thickness of the edges is less than three tenths of an inch in another embodiment in accordance with the invention. And in yet another embodiment in accordance with the invention, the thickness of the edges is less than a tenth of an inch.

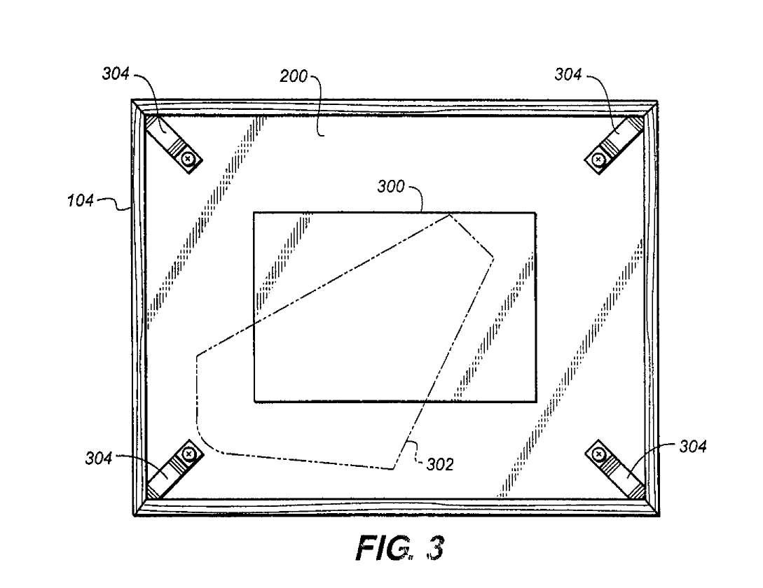

Now referring to FIG. 3, there is shown a back view of conventional picture frame engaged to the back of an electronic display panel in an embodiment in accordance with the invention. The back of electronic display panel 200 includes housing 300 that surrounds the back of display 100 and the electronics needed to operate, or interact with, display 100. Such electronics can include, but are not limited to, memory, processing devices, wireless and wired network devices, power supplies including electrical and battery supplies, and connectors for one or more input/output (I/O) ports and memory slots.

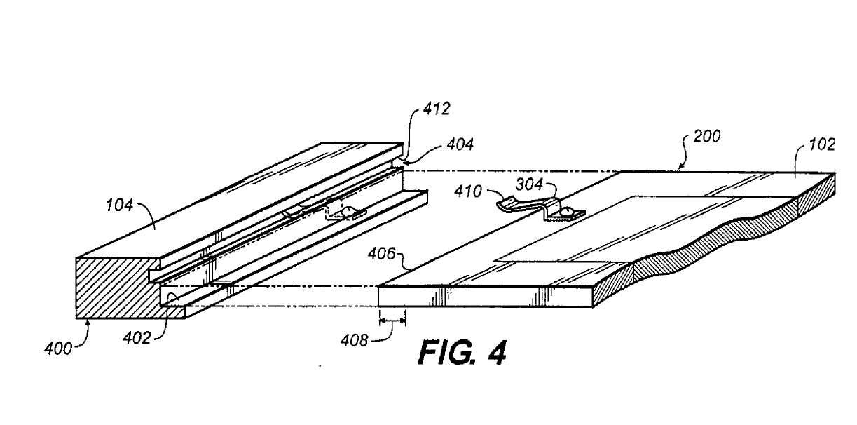

The back of electronic display panel 200 may also include a conventional hinged stand 302 that enables the combination of electronic display panel 200 and conventional picture frame 104 to rest or stand upright on a surface. In the embodiment shown in FIG. 3, the back of bordering housing 102 includes multiple deflectable clips 304 that are used to engage or connect conventional picture frame 104 to electronic display panel 200. Different types of connection means, described herein in conjunction with FIGS. 4-13, are used to engage frame 104 to panel 200.

FIG. 4 is a perspective rear view of one side of the conventional picture frame and the electronic display panel in a first embodiment in accordance with the invention. Surface 400 is the front side of conventional picture frame 104. Conventional picture frame 104 includes an L-shaped shelf 402 and a slot 404, both of which are formed in all four sides of frame 104 in an embodiment in accordance with the invention. Other embodiments in accordance with the invention can form slot 404 and shelf 402 in three or fewer sides of frame 104.

When placed in opening 106, edge 406 of bordering housing 102 and a portion 408 of the front side of bordering housing 102 are positioned or rest in L-shaped shelf 402. For the sake of clarity and ease of understanding, housing 300 (see FIG. 3) is not shown on the back of electronic display panel 200 in FIGS. 4-10. Electronic display panel 200 may be placed in conventional picture frame 104 by sliding panel 200 into frame 104 or by dropping electronic display panel 200 into frame 104 in embodiments in accordance with the invention.

Deflectable clip 304 is designed to position edge 410 of clip 304 at a given distance away from the back side of bordering housing 102 when no force is applied to clip 304. To engage conventional picture frame 104 to electronic display panel 200, a sideway force can be applied to deflectable clip 304 to cause clip 304 to rotate away from slot 404. A downward force is then applied to clip 304 to cause edge 410 to deflect or bend toward the back side of bordering housing 102. Next, edge 410 is rotated into slot 404 and the downward force removed from clip 304. Removal of the force causes edge 410 to move upward within slot 404 until edge 410 restrainably rests on side 412 of slot 404. Edge 410 of clip 304 is held in slot 404 by the spring-like functionality of clip 304. This process is repeated for each clip 304 on electronic display panel 200. Electronic display panel 200 is engaged with frame 104 when all of the deflectable clips 304 have been inserted into slot 404.

To disengage conventional picture frame 104 from electronic display panel 200, a downward force is applied to clip 304 to cause edge 410 to deflect away from side 412 of slot 404. A sideway force is then applied to clip 304 to cause edge 410 to rotate out of slot 404. This process is repeated for each clip 304 on electronic display panel 200. When all of the deflectable clips 304 have been disengaged from slot 404, electronic display panel 200 can be removed or separated from conventional picture frame 104.

Bordering housing 102 includes two or more deflectable clips 304 in an embodiment in accordance with the invention. These clips 304 can be located anywhere on bordering housing 102. For example, in one embodiment in accordance with the invention, deflectable clips 304 are positioned at each corner of bordering housing 102.

In other embodiments in accordance with the invention, deflectable clip 304 does not rotate into slot 404. Instead, clip 304 is a slidable clip or a fixed clip that requires a downward force to deflect the clip and allow it to be inserted into slot 404. The different types of deflectable clips can be used individually or in combination with one another to engage frame 104 to electronic display panel 200.

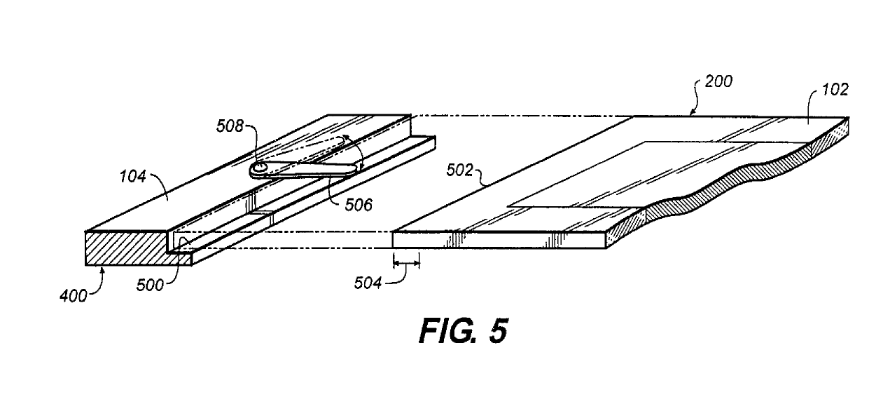

Referring now to FIG. 5, there is shown a perspective rear view of one side of the conventional picture frame and the electronic display panel in a second embodiment in accordance with the invention. Surface 400 is the front side of conventional picture frame 104. Conventional picture frame 104 includes L-shaped shelf 500 that is formed in all four sides of the frame in an embodiment in accordance with the invention.

When placed in opening 106, edge 502 of bordering housing 102 (FIG. 1) and a portion 504 of the front side of bordering housing 102 are positioned or rest in L-shaped shelf 500. Electronic display panel 200 may be placed in conventional picture frame 104 by sliding panel 200 into frame 104 or by dropping electronic display panel 200 into frame 104 in embodiments in accordance with the invention.

Clip 506 is affixed to the back side of frame 104. Clip 506 is designed to rotate around fixed pin 508 in the embodiment of FIG. 5. To engage conventional picture frame 104 to electronic display panel 200, a force is applied to clip 506 to cause clip 506 to rotate and be positioned over bordering housing 102. In the embodiment shown in FIG. 5, clip 506 rests against bordering housing 102 when clip 506 is positioned over bordering housing 102.

To disengage conventional picture frame 104 from electronic display panel 200, a force is applied to clip 506 to cause clip 506 to rotate and be positioned over frame 104 (shown in FIG. 5 with dashed lines). This process is repeated for each clip 304 on electronic display panel 200. When all of clips 506 have been rotated to a position over frame 104, electronic display panel 200 can be removed or separated from conventional picture frame 104.

Conventional picture frame 104 includes two or more clips 506 in an embodiment in accordance with the invention. Clips 506 can be located anywhere on frame 104. For example, in one embodiment in accordance with the invention, clips 506 are affixed on each side of the back side of conventional picture frame 104.

Clip 506 does not rotate in other embodiments in accordance with the invention. Instead, clip 506 is a slidable clip that slides over bordering housing 102 to engage frame 104 to electronic display panel 200. Alternatively, clip 506 is configured as another type of clip that is positioned over bordering housing 102 to engage frame 104 to electronic display panel 200.

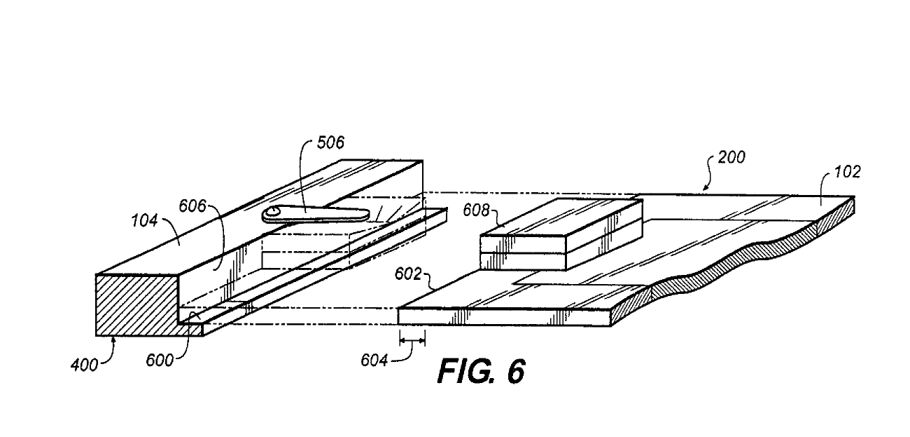

FIG. 6 is a perspective rear view of one side of the conventional picture frame and the electronic display panel in a third embodiment in accordance with the invention. Surface 400 is the front side of conventional picture frame 104. Conventional picture frame 104 includes L-shaped shelf 600 that is formed in all four sides of the frame in an embodiment in accordance with the invention.

When placed in opening 106 of conventional picture frame 104, edge 602 of bordering housing 102 and a portion 604 of the front side of bordering housing 102 are positioned or rest in L-shaped shelf 600. But in the embodiment of FIG. 6, the height of side 606 of L-shaped shelf 600 is greater than the thickness of bordering housing 102 of electronic display panel 200. Thus, clip 506 does not rest against bordering housing 102 when clip 506 is positioned over bordering housing 102.

Expansion layer 608 is placed on, or affixed to, a portion of bordering housing 102 that corresponds to the location of clip 506. This allows clip 506 to rest against the top surface of expansion layer 608 when clip 506 is positioned over expansion layer 608. Thus, the combination of clip 506 and expansion layer 608 is used to engage conventional picture frame 104 to electronic display panel 200.

Conventional picture frame 104 includes two or more clips 506 and bordering housing 102 a correspondingly number of expansion layers 608 in an embodiment in accordance with the invention. Expansion layer 608 can be formed with one or more layers of any type of material or combination of materials. For example, expansion layer 608 can be fabricated using foam, rubber, spring steel, molded plastic, springs, or any combination thereof.

In other embodiments in accordance with the invention, expansive layer 608 can be located around the outer edge of bordering housing 102. Alternatively, expansive layer 608 can be molded to avoid any permanent attachments to bordering housing 102. Expansive layer 608 can have a hard skin on each side with a softer expansive material in between. Expansive layer 608 can have adhesive on one or both sides to help secure it to bordering housing 104, or conventional picture frame 104, or both.

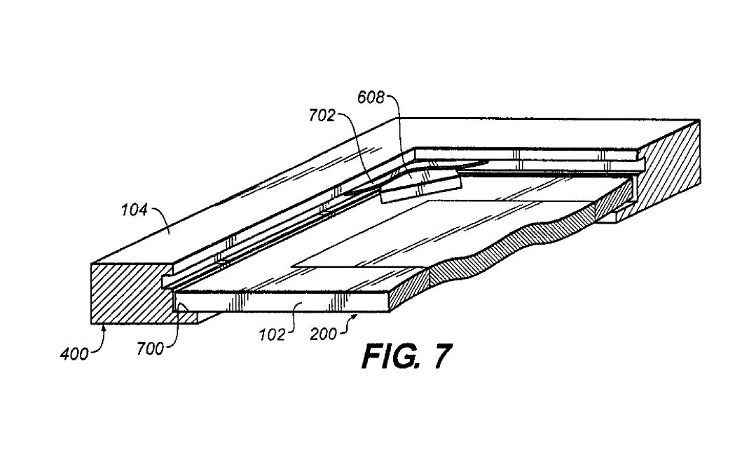

Referring now to FIG. 7, there is shown a perspective rear view of one corner of the conventional picture frame and the electronic display panel in a fourth embodiment in accordance with the invention. Surface 400 is the front side of conventional picture frame 104. Conventional picture frame 104 includes L-shaped shelf 700 that is formed in all four sides of the frame in an embodiment in accordance with the invention.

When placed in opening 106, the edges of bordering housing 102 and portions of the front side of bordering housing 102 are positioned or rest in L-shaped shelf 700. Electronic display panel 200 (FIG. 2) may be placed in conventional picture frame 104 by sliding panel 200 into frame 104 or by dropping electronic display panel 200 into frame 104 in embodiments in accordance with the invention.

Corner clip 702 is inserted into the back side of frame 104. Clip 702 is designed to be inserted into a corner of convention picture frame and the two corresponding sides of frame 104 that form the corner. Expansion layer 608 is positioned between corner clip 702 and electronic display panel 200 in the embodiment shown in FIG. 7. Thus, the combination of corner clip 702 and expansion layer 608 is used to engage conventional picture frame 104 to electronic display panel 200.

To disengage conventional picture frame 104 from electronic display panel 200, corner clip 702 is removed from the corner of conventional picture frame 104. If necessary, expansion layer 608 is also removed from the corner. This process is repeated for each corner clip 702. When all of the corner clips 702 have been removed from the corners of frame 104, electronic display panel 200 can be removed or separated from conventional picture frame 104.

Two or more corner clips 702, and if necessary expansion layers 608, are used to engage conventional picture frame 104 to electronic display panel 200 in an embodiment in accordance with the invention. For example, in one embodiment in accordance with the invention, a corner clip 702 can be inserted into each corner of conventional picture frame 104. In another embodiment in accordance with the invention, a corner clip 702 can be inserted into each of two diagonal opposing corners of conventional picture frame 104.

In other embodiments in accordance with the invention, expansive layer 608 is not used with corner clip 702. Instead, corner clip 702 includes a loop or spring or some other type of device that is positioned between clip 702 and the back of electronic display panel 200. And in yet another embodiment in accordance with the invention, corner clip 702 is used by itself to engage frame 104 to electronic display panel 200.

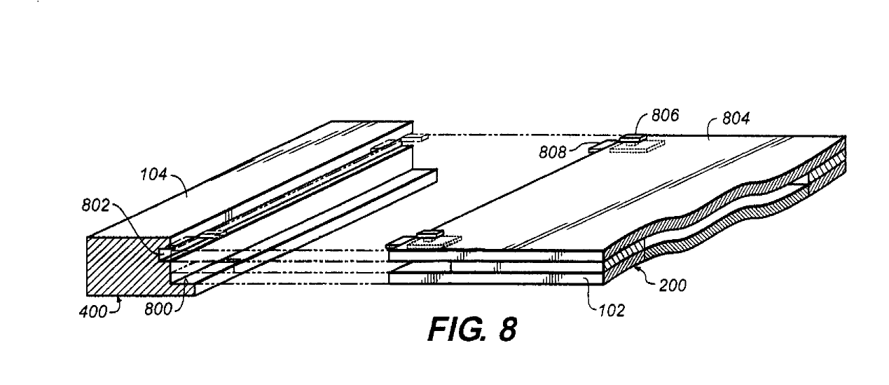

FIG. 8 a perspective rear view of one corner of the conventional picture frame and the electronic display panel in a fifth embodiment in accordance with the invention. Surface 400 is the front side of conventional picture frame 104. Conventional picture frame 104 includes L-shaped shelf 800 and a slot 802 that are formed in all four sides of the frame in an embodiment in accordance with the invention.

When placed in opening 106 of conventional picture frame 104 (FIG. 1), the edges of bordering housing 102 and portions of the front side of bordering housing 102 are positioned or rest in L-shaped shelf 800. Electronic display panel 200 may be placed in conventional picture frame 104 by sliding panel 200 into frame 104 or by dropping electronic display panel 200 into frame 104 in embodiments in accordance with the invention.

Holdback plate 804 is placed on top of at least the outer portions of bordering housing 102 and includes tabs 808. Tabs 808 can be above or below the viewable surface of holdback plate 804. Tab 808 can be a slider, rotating clip, or other attachment device in embodiment in accordance with the invention. There may be one or more expansive layers added between plate 804 and bordering housing 102 to accommodate when slot 802 is a different height from surface 800.

To engage conventional picture frame 104 to electronic display panel 200, a force is applied to button 806 to cause tab 808 to extend into slot 802. This process is repeated for each tab 808 included with holdback plate 804. Two or more tabs 808 can be used with holdback plate 804 to engage conventional picture frame 104 to electronic display panel 200 in an embodiment in accordance with the invention.

To disengage conventional picture frame 104 from electronic display panel 200, a force is applied to button 806 to cause tab 808 to retract towards holdback plate 804. When all of tabs 808 are retracted, electronic display panel 200 can be removed or separated from conventional picture frame 104.

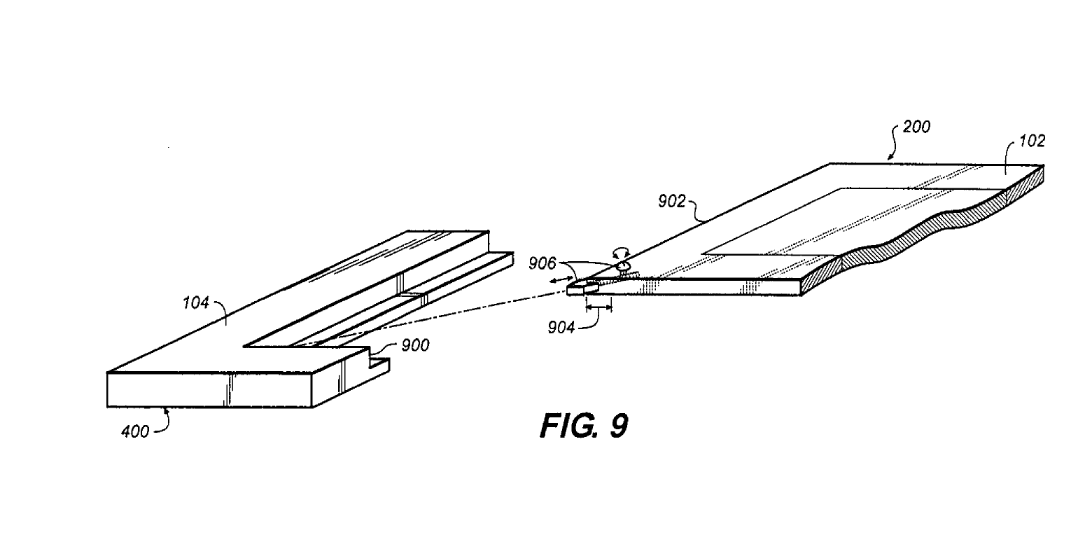

Referring now to FIG. 9, there is shown a perspective rear view of one side of the conventional picture frame and the electronic display panel in a sixth embodiment in accordance with the invention. Surface 400 is the front side of conventional picture frame 104. Conventional picture frame 104 includes L-shaped shelf 900 that is formed in all four sides of frame 104 in an embodiment in accordance with the invention.

When placed in opening 106 of conventional picture frame 104, the edges 902 of bordering housing 102 and portions 904 of the front side of bordering housing 102 are positioned or rest in L-shaped shelf 900. Electronic display panel 200 may be placed in conventional picture frame 104 by sliding panel 200 into frame 104 or by dropping electronic display panel 200 into frame 104 in embodiments in accordance with the invention.

Pressure connector 906 is included within, or affixed to the back of, electronic display panel 200. Pressure connector 906 is designed to be extendable to apply a force against at least one side of L-shaped shelf 900. By way of example only, pressure connector 906 can be implemented as a screw, a set screw, a slider, or any combination thereof. Two or more pressure connectors 906 are used to engage conventional picture frame 104 to electronic display panel 200 in an embodiment in accordance with the invention. For example, in one embodiment in accordance with the invention, two pressure connectors 906 on opposing sides of electronic display panel 200 are used to engage conventional picture frame 104 to electronic display panel 200.

To disengage conventional picture frame 104 from electronic display panel 200, each pressure connector 906 is shortened or withdrawn from the one or more sides of L-shaped shelf 900. When all of the pressure connectors 906 have been withdrawn, electronic display panel 200 can be removed or separated from conventional picture frame 104.

Frictional material (not shown) can be added around edge 902 or in the corners of frame 104, bordering housing 102, or both, to enhance the strength of the engagement of frame 104 to electronic display panel 200. The frictional material can be formed from rubber, non-slip fabric, electronic display housing finish texture, or any other material with frictional properties.

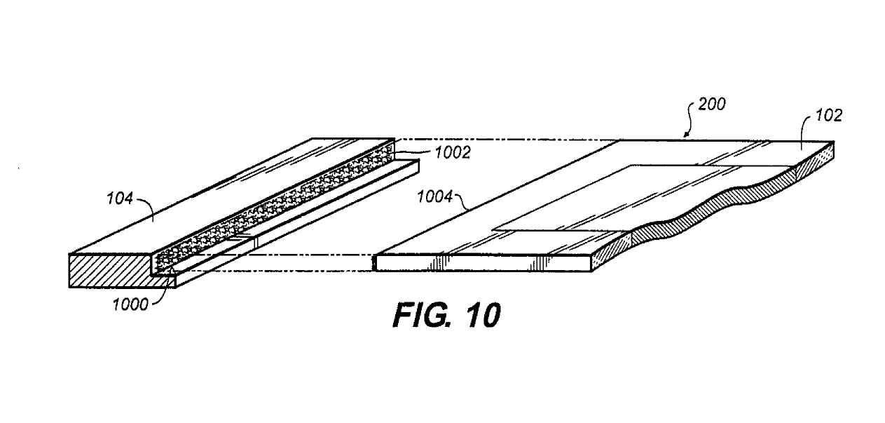

FIG. 10 is a perspective rear view of one side of the conventional picture frame and the electronic display panel in a seventh embodiment in accordance with the invention. Surface 400 is the front side of conventional picture frame 104. Conventional picture frame 104 includes L-shaped shelf 1000 that is formed in all four sides of frame 104 in an embodiment in accordance with the invention.

When placed in opening 106, the edges of bordering housing 102 and portions of the front side of bordering housing 102 are positioned or rest in L-shaped shelf 1000. Electronic display panel 200 may be placed in conventional picture frame 104 by sliding panel 200 into frame 104 or by dropping electronic display panel 200 into frame 104 in embodiments in accordance with the invention.

Adhesive connector 1002 is used to affix one or more edges of electronic display panel 200 to one or more sides of L-shaped shelf 1000. For example, adhesive connector 1002 is implemented as a hook and loop connector, such as Velcro®, in an embodiment in accordance with the invention. Thus, one or more strips of the hook or loop material is affixed to at least one side of L-shaped shelf 1000 and the loop or hook material, respectively, is affixed to edge 1004 of electronic display panel 200. Conventional picture frame 104 is engaged with electronic display panel 200 when all of the edges of electronic display panel 200 having an adhesive connector are attached to corresponding adhesive connectors on conventional picture frame 104.

To disengage conventional picture frame 104 from electronic display panel 200, the edges of electronic display panel 200 having an adhesive connector are separated from their corresponding adhesive connectors on conventional picture frame 104. Electronic display panel 200 is now removable from conventional picture frame 104.

In other embodiments in accordance with the invention, different types of adhesive connectors can be used. For example, temporary glue or other temporary liquid adhesive or two-sided tape can be used as an adhesive connector.

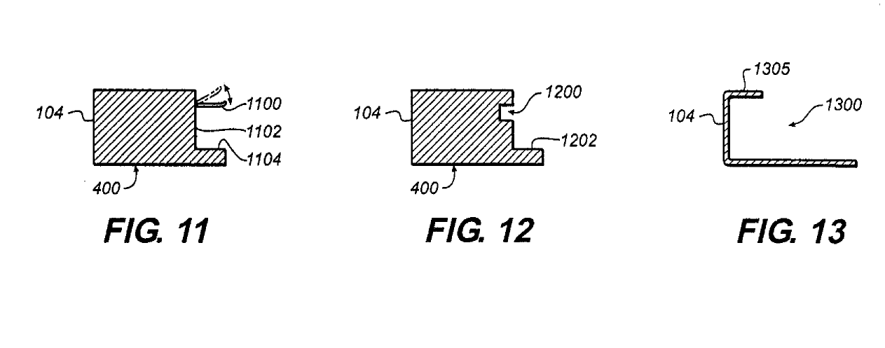

FIGS. 11-13 depict cross-sectional views of a side of a conventional picture frame having alternative connection means that can be used to engage the conventional picture frame to an electronic display panel. FIG. 11 illustrates a tab connector 1100 that is included in two or more sides of conventional picture frame 104. For example, each side of the back side of conventional picture frame 104 can include one or more tab connectors 1100.

Surface 400 is the front side of conventional picture frame 104. Conventional picture frame 104 includes L-shaped shelf 1102 that is formed in all four sides of frame 104 in an embodiment in accordance with the invention. To engage conventional picture frame 104 to electronic display panel 200, an upward force is applied tab connector 1100 to cause tab connector 1100 to lift up and away from surface 1104 (shown in FIG. 11 with dashed lines).

This process is repeated for each tab connector 1100 in frame 104. When all tab connectors 1100 are lifted away from surface 1104, electronic display panel 200 can be placed in conventional picture frame 104 such that the front side edges of electronic display panel 200 rest upon surface 1104. A downward force is then applied to each tab connector 1100 until the tab connectors 1100 rest against the back side of electronic display panel 200. The steps of the engagement process are reversed to disengage electronic display panel 200 from conventional picture frame 104.

FIG. 12 depicts a slot connector 1200 that is included in one side of conventional picture frame 104. Slot connector 1200 is used in conjunction with the rotatable clips 506 (FIG. 5) or tab connectors 1100 (FIG. 11) in an embodiment in accordance with the invention. To engage conventional picture frame 104 to electronic display panel 200, electronic one edge of electronic display panel 200 is inserted into slot 400 prior to placing the front side edges of electronic display panel on surface 1202.

Rotatable clips 506 or tab connectors 1100 are located on the back side of conventional picture frame at a side of conventional picture frame 104 that opposes slot 1200. If desired, additional rotatable clips 506 or tab connectors 1100 can be located on the other sides of conventional picture frame 104. Once the front side edges of electronic display panel rest on surface 1202, rotatable clips 506 or tab connectors 1100 are positioned over the back side of electronic display panel 200 to engage electronic display panel 200 to frame 104. The steps of the engagement process are reversed to disengage electronic display panel 200 to frame 104.

FIG. 13 illustrates a slide-in-slot connector that can be used to engage electronic display panel 200 to conventional picture frame 104. Slot 1300 is formed in three sides of conventional picture frame 104. The fourth side of frame 104 is open to allow a side of electronic display panel 200 to be inserted into slots 1300 on the two opposing sides of frame 104. Electronic display panel 200 can then be slid into frame 104. This process is reversed to remove electronic display panel 200 from conventional picture frame 104.

Although the various connection means have been described individually, two or more connection means can be used together in one or more embodiments in accordance with the invention. By way of example only, the deflectable clips 304 (see FIG. 4) can be used with rotatable clips 506 (FIG. 5) or tab connectors 1100 (FIG. 11). Moreover, the different connection means can be fabricated from metal, plastic, wood, or any other appropriate material that can securely fasten the electronic display panel 200 (FIG. 2) to conventional picture frame 104 (FIG. 1). And finally, the expansive layer (e.g., 608 in FIG. 6) can be used with embodiments other than the embodiments of FIGS. 6 and 7. For example, an expansive layer can be used with the tab connector 1100 shown in FIG. 11 or the slide-in-slot connection of FIG. 13. In the embodiment of FIG. 11, the expansive layer would be positioned between tab 1100 and electronic display panel 200. With embodiment of FIG. 13, the expansive layer is positioned between edge 1305 of the slide-in-slot connection and electronic display panel 200.

### PARTS LIST

100 display
102 bordering housing
104 conventional picture frame
200 electronic display panel
300 housing
302 hinged stand
304 deflectable clips
400 surface
402 shelf
404 slot
406 edge of bordering housing
408 portion of the front side of bordering housing
410 edge of deflectable clip
412 side
500 shelf
502 edge of bordering housing
504 portion of the front side of bordering housing
506 clip
508 fixed pin
600 shelf
602 edge of bordering housing
604 portion of the front side of bordering housing
606 side of shelf
608 expansion layer
700 shelf
702 corner clip
800 shelf
802 slot
804 holdback plate
806 button
808 tabs
900 shelf
902 edge of bordering housing
904 portion of the front side of bordering housing
906 pressure connector
1000 shelf
1002 adhesive connector
1100 tab connector
1102 shelf
1104 surface
1200 connector
1202 surface
1300 slot
1305 edge

1. A display device, comprising:
an electronic display panel including a display and a bordering housing surrounding the display, wherein a height, a width, and a thickness of bordering housing are all configured to allow electronic display panel to be engagable with a plurality of conventional picture frames;
a respective conventional picture frame having an opening and a plurality of rotatable clips affixed to the conventional picture frame that rotate over a backside of the bordering housing to detachably engage the electronic display to the respective conventional picture frame; and
one or more expansive layers positioned between each rotatable clip and the backside of the bordering housing.

2. The display device of claim 1, where the thickness of the bordering housing edges is less than three tenths of an inch.

3. The display device of claim 1, where the thickness of the bordering housing edges is less than two tenths of an inch.

4. The display device of claim 1, where the thickness of the bordering housing edges is less than one tenth of an inch.

5. A display device, comprising:
an electronic display panel including a display and a bordering housing surrounding the display, wherein a height, a width, and a thickness of bordering housing are all configured to allow electronic display panel to be engagable with a plurality of conventional picture frames;
a respective conventional picture frame having an opening, four sides that extend out perpendicular from the opening and surround the opening, and a slot formed in at least two sides, where the opening in the respective conventional picture frame allows the display to be visible when the electronic display housing is engaged with the respective conventional picture frame; and
a plurality of deflectable clips affixed to a backside of the bordering housing, wherein each deflectable clip deflects toward a backside of the bordering housing in response to a force applied to each clip to allow an edge on the clip to rotate into a respective slot and detachably engage the electronic display to the respective conventional picture frame.

6. The display device of claim 5, further comprising one or more expansive layers positioned between each rotatable clip and the backside of the bordering housing.

7. The display device of claim 5, where the thickness of the bordering housing edges is less than three tenths of an inch.

8. The display device of claim 5, where the thickness of the bordering housing edges is less than two tenths of an inch.

9. The display device of claim 5, where the thickness of the bordering housing edges is less than one tenth of an inch.

10. A display device, comprising:
an electronic display panel including a display and a bordering housing surrounding the display, wherein a height, a width, and a thickness of bordering housing are all configured to allow electronic display panel to be engagable with a plurality of conventional picture frames;
a respective conventional picture frame having an opening, four sides that extend out perpendicular from the opening and surround the opening, and a slot formed in at least two sides, where the opening in the respective conventional picture frame allows the display to be visible when the electronic display housing is engaged with the respective conventional picture frame; and
a holdback plate disposed over at least a portion of the bordering housing, wherein the holdback plate includes a plurality of movable tabs disposed on a backside of the holdback plate that insert into the slot to detachably engage the electronic display to the respective conventional picture frame.

11. The display device of claim 10, further comprising one or more expansive layers positioned between each rotatable clip and the backside of the bordering housing.

12. The display device of claim 10, where the thickness of the bordering housing edges is less than three tenths of an inch.

13. The display device of claim 10, where the thickness of the bordering housing edges is less than two tenths of an inch.

14. The display device of claim 10, where the thickness of the bordering housing edges is less than one tenth of an inch.
